(19) United States
(12) Patent Application Publication
(10) Pub. No.: US 2026/0097999 A1
(43) Pub. Date: Apr. 9, 2026

(54) BIOTIC PELLETIZED MULCH AND SOIL AMENDMENT

(71) Applicant: PROFILE PRODUCTS LLC, Buffalo Grove, IL (US)

(72) Inventors: Ronald Charles EDWARDS, Worley, ID (US); Matthew Michael WELCH, Menasha, WI (US); Michael Dan ROBESON, Windsor, CO (US)

(73) Assignee: PROFILE PRODUCTS LLC, Buffalo Grove, IL (US)

(21) Appl. No.: 19/348,926

(22) Filed: Oct. 3, 2025

Related U.S. Application Data
(60) Provisional application No. 63/702,923, filed on Oct. 3, 2024.

(51) Int. Cl. C05G 3/80; C05G 5/14

(52) U.S. Cl. CPC C05G 3/80; C05G 5/14

(57) ABSTRACT

A mulch and soil amendment includes a plurality of pellets, each having a first state of being an extruded compact elongated body having a smooth surface, and a second state of being a non-compact material having a rough surface, each pellet, of the mulch and soil amendment, having a composition comprising: straw; cellulose material; tackifier, crosslinker; and aqueous solution of acids.

### CROSS-REFERENCE TO RELATED APPLICATIONS

This application claims the benefit of U.S. Provisional Application No. 63/702,923, filed Oct. 3, 2024, the disclosure of which is hereby incorporated in its entirety by reference herein.

### TECHNICAL FIELD

The present disclosure is related to a straw-based pelletized material and methods of making and using the same as a mulch and soil amendment.

### BACKGROUND

Mulch is useful for improving moisture retention, suppressing the growth of weeds thereby improving plant growth, regulating soil temperature, and preventing soil erosion. Organic mulch also delivers nutrients to the soil, which improves the health of the soil, further aiding plant growth. Organic mulch, traditionally made from wood chips and other components such as bark, sawdust, or pine needles, has been used to prevent soil erosion. Uncontrolled erosion can result in environmental damage including flooding of surrounding areas, pollution of rivers and lakes, and/or injury to plant and animal life. Erosion also results in loss of fertile topsoil which reduces chances of vegetation survival and increases the erosion cycle.

### SUMMARY

In one or more embodiments, a pelletized mulch and soil amendment is disclosed. The pelletized mulch and soil amendment including a plurality of pellets, a first state of being an extruded compact elongated body having a smooth surface, and a second state of being a non-compact material having a rough surface. Each pellet may have a composition comprising the following components: straw, tackifier, fertilizer, aqueous solution of acids, crosslinker, surfactant, and biostimulants.

In another embodiment, a mulch and soil amendment is disclosed. The mulch and soil amendment includes a plurality of pellets, each having a first state of being an extruded compact elongated body having a smooth surface, and a second state of being a non-compact material having a rough surface, each pellet, of the mulch and soil amendment, having a composition comprising: straw; cellulose material; tackifier; crosslinker; and aqueous solution of acids. The straw may include alfalfa. The composition may include about 80 to 95 wt. % straw, based on a total weight of the composition. The composition may further include a fertilizer and the amount of the tackifier and the fertilizer is within 1 wt. % of each other, based on the total weight of the composition. The aqueous solution of acids may include a mixture of hydrochloric acid and phosphoric acid. The composition may further include inoculants of Mycorrhizae. The crosslinker may include glyoxal.

In another embodiment, a pelletized material is disclosed. The pelletized material includes a plurality of pelletized extruded and compact bodies, each one of the bodies having a compressed mass of a mulch and soil amendment composition, each one of the bodies having a moisture content of at most about 15 wt. %, based on the total weight of a body, in its inactive first state, at least about 10 wt. % of the pelletized extruded and compact bodies being angular with non-rounded geometry, based on the total weight of the pelletized material. The plurality of pelletized extruded and compact bodies has a second active state of being expanded at a moisture content greater than about 15 wt. %, based on the total weight of the pelletized material. The angular bodies may be irregularly shaped. Some of the plurality of pelletized extruded and compact bodies may vary in length relative to one another. The mulch and soil amendment composition may include straw, cellulose material, tackifier, crosslinker, and aqueous solution of acids. The cellulose material may include paper. The composition may further include one or more of fertilizer(s), surfactant(s), and biostimulant(s).

In yet another embodiment, a pelletized material is disclosed. The pelletized material includes a plurality of pellets, each pellet having, in a first state, a moisture content of at most about 15 wt. %, based on a total weight of the pellet, and maintaining a compressed geometry; and upon exposure to moisture, a second state, in which the pellet swells such that at least one dimension of the pellet increases relative to the first state, the pellet in the second state being configured to rupture and disintegrate into a plurality of portions smaller than the compressed geometry of the first state, the pelletized material being a straw-based mulch and a soil amendment composition. The straw-based mulch and a soil amendment composition may include straw; cellulose material; tackifier; crosslinker; and aqueous solution of acids. The plurality of pellets may include at least a portion of the pellets having angular, non-round pellets. The aqueous solution of acids may include a mixture of hydrochloric acid and phosphoric acid. The straw and cellulose material may form at least 85 wt. % of the composition, based on the total weight of the composition. The composition may further include one or more of fertilizer(s), surfactant(s), and biostimulant(s).

### BRIEF DESCRIPTION OF THE DRAWINGS

FIG. 1A is a photograph of the pelletized mulch and soil amendment, according to one or more embodiments disclosed herein, in its first state;

FIG. 1B shows the pelletized mulch and soil amendment of FIG. 1A in the second state, after moisture application;

FIG. 2A is a photograph of a single pellet of the pelletized mulch and soil amendment, according to one or more embodiments disclosed herein, in its first state;

FIG. 2B shows the pellet of FIG. 2A in the second state, after moisture application;

FIG. 3 is a photograph of the pelletized mulch and soil amendment, according to one or more embodiments disclosed herein, in its second state applied over coal mine spoils;

FIG. 4A is a photograph of Comparative Example A in the beginning of the trial referenced in the Experimental section;

FIG. 4B is a photograph of Comparative Example B in the beginning of the trial referenced in the Experimental section;

FIG. 5 is a photograph of Examples 1, 2, and 3, in their second state, in the beginning of the trial referenced in the Experimental section;

FIGS. 6A and 6B are photographs of Example 1 at 9 weeks of the trial referenced in the Experimental section;

FIGS. 7A and 7B are photographs of Example 2 at 9 weeks of the trial referenced in the Experimental section;

FIGS. 8A and 8B are photographs of Example 3 at 9 weeks of the trial referenced in the Experimental section; and

FIGS. 9A and 9B are photographs of Comparative Examples A and B, respectively, at 9 weeks of the trial referenced in the Experimental section.

### DETAILED DESCRIPTION

As required, detailed embodiments of the present invention are disclosed herein; however, it is to be understood that the disclosed embodiments are merely exemplary of the invention that may be embodied in various and alternative forms. The figure is not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The understanding that land use by humans affects the health and utility of soil predates modern nations. Ancient Helens theorized that deforestation of Greek hillsides led to soil erosion and consequently deterioration of the health of the soil. Modern soil studies in the region confirmed their theories, linking significant erosion events not to the drastic climate change of the last glaciation, but to the introduction of farming. The existence of ancient erosion control measures such as terraced hillsides on virtually every inhabited continent further suggest that ancient peoples understood the importance of preserving soil.

In the 1920's, Hugh Hammond Bennett, nicknamed the “father of soil conservation,” pushed the United States Congress to begin studying the effects of erosion and the importance of soil preservation. The dust bowl crisis of 1932 cemented the necessity for preserving soil in the minds of Americans and prompted the New Deal administration to focus on soil conservation, passing the Soil Conservation Act of 1935. Since then, numerous soil conservation measures have been implemented to control erosion in various sectors including farming, construction, and highway embankment design.

Recently, the effects of climate change such as extreme weather patterns, fires, mudslides, overpopulation, and insensitive industrial decisions have accelerated erosion problems around the globe. For example, dust plumes generated by wind erosion from the Sahara Desert are increasingly traveling beyond the Mediterranean Sea into Southern Europe, and even as far as the Gulf Coast of the United States. The Western part of the United States, Australia, and other arid and semi-arid areas are similarly experiencing unprecedented erosion rates. Additionally, areas with no lack of water and precipitation, such as the Great Lakes region and deforested areas of Asian countries are being forced to tackle new erosion problems associated with loss of land due to landslides, river and lake bank erosion, etc. Thus, there is a significant interest and incentive to stop, prevent, and where possible, reverse erosion.

Any soil that is not covered may be susceptible to erosion by wind and water. Farmland is particularly susceptible to erosion due to the deforestation and clearing necessary to grow specific crops. Erosion on farmland is detrimental to crops, as disturbing topsoil reduces organic matter in the soil, decreases rooting depth, and affects the amount of nutrients, water and air available to plants. In addition to lowering crop yield, nutrient and sediment run off can pollute rivers and lakes causing flooding of surrounding areas and injury to plants and animals. Additionally, dust generated by wind erosion can reduce air quality and negatively impact human and animal health. Farmers utilize various methods of erosion control including crop rotation, cover crops, grassed waterways, and mulching.

The soil itself has also been subject to damage and nutrient depletion, for example as a result of use of heavy machinery, insensitive farming techniques, and over use. As a result, soil, in general, is less nutritious and can produce only less nutritious foods without heavy fertilization in comparison with the past decades and centuries. Fertilization, in turn, may increase undesirable salinity and further devaluate quality of the soil. The damaged soil also lacks healthy microbiome which has direct affect on soil structure and fertility.

Construction sites are another major contributor to soil erosion in part because the land must be cleared for construction to begin, but also because topsoil is physically removed or altered to dig basements, grade sites, or fill sites. Developers prevent erosion control by utilizing physical barriers (i.e. rocks, concrete blocks, earth walls), but also by establishing vegetation at the site using seeds and mulch.

There are several categories of mulch, for example hydroseeding or hydraulic mulches, which are formed by mixing solid components with water and applied hydraulically from high-pressure sprayers. The water-based mulch is typically transported and applied from mobile heavy machine including a storage tank connected to the sprayer. Such application has become popular due to certain advantages such as the ability to disperse mulch over an area with uneven topography, provide a desirable thickness, consistency, and a relatively fast application.

But hydraulic mulches require water in relatively large quantities for their application. The mulch composition is mixed with water in a tank and expelled under pressure via a hose. Thus, hydraulic mulches typically require water availability. This poses a problem in arid zones, semi-arid areas, or regions where water availability is scarce or economically restrictive. Additionally, the rate of erosion and need to amend the soil is typically high in these areas. With the growing concerns regarding water availability around the world, there is a need to provide alternative options.

Additionally, remote regions, which are spatially removed from sources of available water or sites with spatial limitations may not be able to utilize hydroseeding techniques. Examples may include mining sites and solar sites. For instance, solar sites include rows of relatively fragile solar panels placed in relatively close proximity of one another. As a result, heavy machinery presents a considerable risk among the solar panels, yet, solar panels are frequently in need of erosion prevention.

Hence, a limited amount of mulches have been developed in a pelletized form. For example, some pelletized mulches are formed using recycled wood, paper, and/or cellulose fibers and pressed into pellets. To activate, the pellets have to absorb water and rupture. The ruptured material then forms a matrix. However; some pellet materials have been observed to remain in their unruptured state or rupture just partially even after moisture is applied. The lack of rupturing may thus result in unopened pellets which do not provide erosion control. Furthermore, some pelletized mulches have been shown to succumb to gravitational pull when applied onto slopes, thus rolling downhill from the application site and leaving the site without proper treatment. Additionally, pelletized or hydraulic mulches typically address only erosion, but do not amend the soil.

In one or more embodiments, a pelletized material is disclosed. The pelletized material may be a mulch, a soil amendment, or both. The term “mulch” or “mulch composition” as used herein means a layer of material that is applied to a soil to reduce erosion, to improve water retention, and/or to hold a seed in place on the soil surface long enough for the seed to germinate and for the root to develop within the soil below the mulch. The layer may be continuous or discontinuous.

The term “soil amendment” as used herein means a material that is added to the soil to improve its chemical properties, physical properties, structure, microbiome resulting in long-term improvements in the soil's quality. A soil amendment is added to improve the environment for plant roots.

The pelletized material may be sustainable, biodegradable, bio-based, or their combination. The material may serve as a replacement for top soil ecosystems, introducing building blocks of a natural ecosystem where such system was previously diminished or lost. The pelletized material may thus repair or replace the soil microbiome, structure, chemical properties of the soil, physical properties of the soil, or their combination.

The pelletized material may be biotic, referring to presence of microorganisms in the material.

The pelletized material may be applied onto a variety of areas including arid, semi-air, mines, reclamation sites, solar sites, remote areas, and areas with water scarcity or obstacles. The material may be a dry delivery mechanism material. The application or delivery of the pellets may be realized by large scale broadcasting such as by aerial application from a helicopter. The application or delivery may be via a spreader such as a drop spreader, rotary spreader, or agricultural spreader. The pellets may be hand-applied. Application via a hydroseeder is also contemplated, the delivery is not via a slurry, but rather dry hydroseeding. The material may be a non-hydraulically applied material.

The material disclosed herein may have two states. In the first state, the material may be characterized as pellets. In a first state, the material or pellets are in a form of extruded bodies. A pellet represents a compressed mass containing the composition of the herein-disclosed material.

The pellets may have the same or different shapes, configuration, dimensions, or their combination. In a non-limiting example, the pellets may include elongated extruded bodies. The elongated extruded bodies may have circular cross-section, a uniform width throughout their length, or both. In another embodiment, the pellets may be angular. Angular may relate to sharp edges, distinct corners, non-spherical, irregular, faceted, jagged, or blocky shape. The angular pellets may be irregularly shaped, prismatic, not rounded. The angular shape may be advantageous in certain application such as on a slope, where a circular or rounded extruded bodies may have a tendency to roll while angular bodies may have a greater ability to be retained in the deposition location.

At least a portion of the pellets may be angular, such as at least 5, 10, 15, 20, 25, 30, 35, 40, 45, or 50 wt. % of the pellets may be angular, based on the total weight of the pelletized material. In a non-limiting example, at least about 10 wt. % of the pelletized extruded and compressed bodies is angular with non-rounded geometry, based on the total weight of the pelletized material. In another embodiment, about 50 wt. % of the pelletized extruded and compressed bodies is angular with non-rounded geometry, based on the total weight of the pelletized material. In another embodiment, majority such as at least 75% of the pelletized extruded and compressed bodies is angular with non-rounded geometry, based on the total weight of the pelletized material.

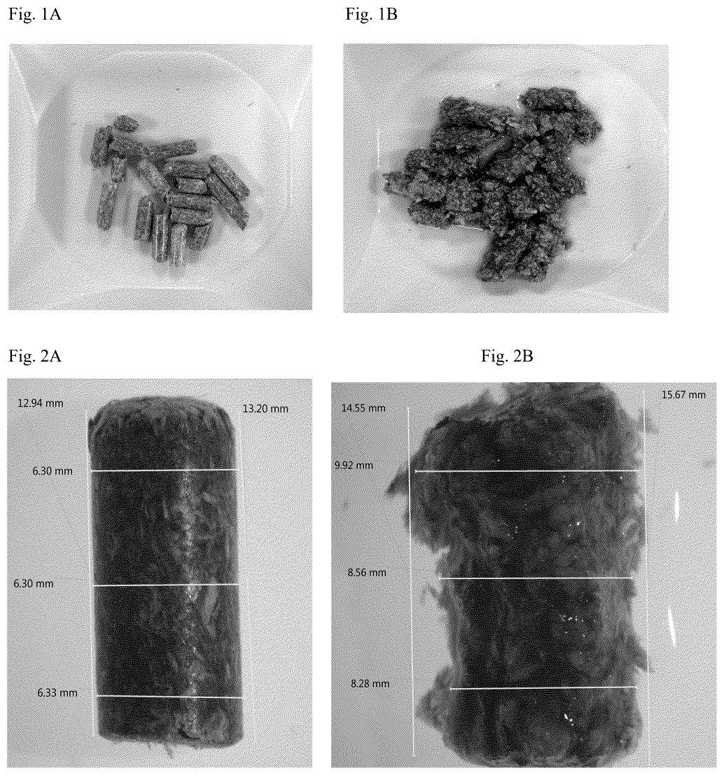

For example, the material may include pellets of various sizes having a generally uniform shape such that a varying dimension among the pellets is their length. A non-limiting example of pellets in the first state are shown in FIGS. 1A and 2A. FIG. 1A shows 10 g of pellets having a composition disclosed herein in a tray. FIG. 2A shows a detailed view of a non-limiting example single pellet with non-limiting example dimensions.

In the first state, a pellet may have a moisture content of at most about 15, 14, 13, 12, 11, 10, 9, 8, 7, 6, 5, 4 or 3%, based on a total weight of a pellet. In the first state, the material is inactive, meaning that it does not fulfill its function as a mulch or soil amendment. The material in the first state is typically in storage, before application, or shortly after application onto a location.

In the second state, the material is activated such that the pellets have increased their moisture content above moisture content of the pellets in the first state, for example, above 15%, based on weight of a pellet. In the initial stage of the second state, the pellets are ruptured or opened by swelling and start to disintegrate and release individual components onto the application site. During the rupture, the outer surface of the pellets is disrupted and starts to disintegrate. In the second state, the pellets are activated to fulfill the material's function as a mulch, soil amendment, or both. In the second state, the compact pellets gradually change into a less compact material body and over time, to a plurality of portions, the portions including one or more of the original components.

Non-limiting examples of the material in the second state is shown in FIGS. 1B, 2B, 3, and 5. FIG. 1B shows the pellets of FIG. 1A 40 minutes after application of 20 ml of water. As can be observed, the pelletized material is visibly swollen compared to the first dry state shown in FIG. 1A. FIG. 2B shows the pellet of FIG. 2A 40 minutes after moisture application. As can be observed, the material has increased its dimensions including length and width throughout its length.

In the second state, at least one dimension may differ from the first state, for example the pellet's width. In the initial stages of the second state, all the dimensions may be greater than in the first state, the greatest increase may be in the width. In the final stages of the second state, the pelletized material of each pellet may disintegrate into a plurality of portions, each portion having smaller dimensions than the original pellet in the first state.

Unlike some state-of-the-art pelletized mulches, the herein-disclosed material in the second state does not form a continuous matrix, blanket, or net. Rather, the herein-disclosed material is effective when the pelletized materials forms pockets or islands of swelled material, is only partially interconnected or in partial contact. The pelletized material effectively holds, retains, and releases moisture to its surrounding, thus providing moisture to the plants growing in the pelletized material's vicinity.

The material in the first and second state may be distributed with such density that the substrate the material is applied onto is visible, as is illustrated in FIGS. 3, 5, and 6A-8B. When applied onto a substrate, the activated material holds moisture adjacent the budding or growing vegetation.

The substrate may include soil of differing quality, coarseness, and composition including sand, clay, rocks, silt, loam, mining and reclamation materials such as mine spoils. Application density may be tailored to a specific application in dependence on the environmental conditions, type of soil, type of vegetation to be grown, climate, water availability, slope, the like, or a combination of these conditions. Example application density may be about 3000-7500, 3500-7000, or 4000-6000 lbs/acre. An example application density may be about, at least about, or at most about 3000, 3100, 3200, 3300, 3400, 3500, 3600, 3700, 3800, 3900, 4000, 4100, 4200, 4300, 4400, 4500, 5000, 5100, 5200, 5300, 5400, 5500, 5600, 5700, 5800, 5900, 6000, 6100, 6200, 6300, 6400, 6500, 6700, 6800, 6900, or 7000 lbs/acre.

The pellets/pelletized material/composition may include, comprise, consist of, or consist essentially of one or more, two or more, or all of the following components:
(A) natural fiber;
(B) cellulose material;
(C) natural binder or tackifier;
(D) nutrients or fertilizer;
(E) aqueous solution of acids;
(F) crosslinker;
(G) surfactant;
(H) biostimulants; and
(I) additional components.

In at least one embodiment, the material may include components (A)-(H). In another embodiment, the material may include components (A)-(I).

The composition may include about 80 to 95, 85 to 90, or 86 to 89 wt. % of the natural fiber, component (A), based on the total weight of the composition. The weight percentage of component (A) may be about, at least about, or at most about 80, 81, 82, 83, 84, 85, 86, 87, 88, 89, 90, 91, 92, 93, 94, or 95 wt. %, based on the total weight of the composition.

The natural fiber, component (A), may include straw, wood fiber, coconut fiber, hemp fiber, or a combination thereof. Component (A) may include a single type of natural fiber, two types of natural fiber, or a blend of more than two types of natural fiber. Component (A) may be free of synthetic fibers such as man-made or artificial fibers based on artificial polymers. Component (A) may be free of one or more of straw, wood fiber, coconut fiber, or hemp fiber.

The term “straw” refers to a byproduct of the crop, plant, or hay production. Hay refers to the crop that is grown and harvested. Hay typically includes a combination of different plant parts including stems, leaves, flowers, and seed. Hay is usually cut and baled. Straw includes the stalks which remain on the field after the hay is harvested. Straw, unlike hay, is thus limited to the lower portions of the plant stalks and does not generally include leaves, flowers, or seeds. The straw may thus consist of or consist essentially of stalks only. Hence, hay and straw have very different purposes, looks, and properties.

The straw may include straw from one or more sources including wheat, legumes, barley, rice, oats, flex, Kentucky Bluegrass, Ryegrass, Tall Fescue, Bentgrass, Fine Fescues, Bermura Bluegrass, Rough Bluegrass, Orchard grass, Brome grass, Red Top grass, Timothy grass, crested wheatgrass, Little Bluestem, Big Bluestem, hemp, kenaf.

The legumes are a family of plants in the family Fabaceae or Leguminosae. The legume-based straw may include straw particles from one or more plants including alfalfa, clover, beans, soybeans, peas, chickpeas, peanuts, lentils, lupins, carob, tamarind, or a combination thereof. The leguminous straw may be the only type of straw included in the composition.

The term wood fiber may include, but is not limited to, fibrous wood including wood chips, wood fiber, bark, needles, or their combination. The fibrous wood may be derived from coniferous and deciduous trees. The wood fiber may be soft wood, hard wood, or a combination thereof. The wood fiber may be fiber of yellow poplar, spruce, cedar such as Western red cedar, fir such as Douglas fir, California redwood, pine such as Ponderosa, Sugar, White, Red, Jack, Longleaf, Turkish, Virginia, Lodgepole, Pitch, Maritime, Sand, Slash, Loblolly, Bristlecone, Austrian, Japanese Black, Japanese White, Lacebark, Mediterranean, Monterey, Caribbean, Queensland, Bunya, Norfolk Island, and Yellow varieties of pine fiber.

For example, fibrous wood may refer to fibrous pine tree wood components including just fibrous pine tree wood or fibrous pine tree wood as well as fibrous tree bark, needles, chips, or a combination thereof. The fibrous wood components may be bark free or substantially bark free.

The wood may be fibrous wood processed with heat, pressure, and/or steam. The wood fiber may be refined or hammermilled. The wood fiber may be refined wood fiber processed in a refiner under stream, pressure, or both.

A non-limiting example particle distribution, water holding capacity (WHC), and porosity of the wood fiber is shown in Table 1. The WHC and porosity, as referred to herein, are measured according to “Procedures for Determining Physical Properties of Horticultural Substrates Using the NCSU Porometer by Horticultural Substrates Laboratory,” Department of Horticultural Science, North Carolina State University in Raleigh, North Carolina, which is incorporated in its entirety by reference herein. It is the maximum amount of water the growing medium can hold. The sum of water and air holding capacity equal total porosity for a given density and moisture content. Total porosity defines the total volume of pores and refers to percent volume of a substrate that is comprised of pores, or holes. It is the volume fraction which provides the water and aeration in a substrate. The total porosity+the percent solids=100%.

TABLE 1
Non-limiting example of wood fiber classification, WHC, and porosity

| | | Materials: wt. % wood components/wt. % bark | | | | | | |
|---|---|---|---|---|---|---|---|---|
| | | 90%/ | 70%/ | 50%/ | 30%/ | 10%/ | 100%/ | Particle |
| | | 10% | 30% | 50% | 70% | 90% | 0% | size ranges |
| | #8/2360 | 15.9 | 26.7 | 21.0 | 8.6 | 4.7 | 12.4 | 4-25 |
| | [wt. %] | | | | | | | |
| Sieves | #16/1180 | 23.8 | 16.3 | 9.6 | 10.1 | 8.9 | 23.8 | 9-30 |
| Mesh/μm | [wt. %] | | | | | | | |
| | #25/710 | 25.0 | 14.9 | 12.5 | 13.7 | 10.1 | 24.2 | 15-35 |
| | [wt. %] | | | | | | | |
| | #50/300 | 20.7 | 17.6 | 25.6 | 27.0 | 25.4 | 21.5 | 15-30 |
| | [wt. %] | | | | | | | |
| | #100/150 | 10.0 | 13.5 | 15.4 | 21.1 | 20.4 | 10.3 | 6-15 |
| | [wt. %] | | | | | | | |
| | pan/<150 | 4.6 | 11.0 | 15.9 | 19.5 | 26.4 | 7.3 | 2-20 |
| | [wt. %] | | | | | | | |
| Total | Porometer | 96-99 | 94-98 | 93-97 | 91-95 | 88-94 | 96-99 | 88-99 |
| porosity | [vol. %] | | | | | | | |
| Density | Range | 1.5-2; | 1.5-2.5; | 2-3.25; | 3-5; | 3.5-6.5; | 1.2-2.2; | 1.5-6.5; |
| | [lb/ft³]; | 24-32 | 24-40 | 32-52 | 48-80 | 56-104 | 19-35 | 24-104 |
| | [kg/m³] | | | | | | | |
| WHC | ASTM | 825-925 | 725-825 | 625-725 | 500-625 | 400-500 | 800-1000 | 400-1000 |
| | D7367-14 | | | | | | | |
| | [wt. %] | | | | | | | |

The natural fibers of component (A) may be hammermilled, separately or together. The term “hammermilled” as used herein means for a substance to be subjected to a machine called a hammermill. The hammermill grinds the materials to produce particles of reduced size. The material to be hammermilled enters the grinding chamber of the hammermill and is split into smaller particles by the rotation of the hammers and the grinding bridge. The particles produced by grinding are expelled through a screen with openings of a selected size and shape. The hammermill can be fitted with various screen and hammer combinations to achieve the desired particle size. Additionally, hammermills can be screenless, in which case smaller particles are separated from larger ones using airflow. Hammermilling may impart unique desirable properties to the fibers. For example, hammermilling may rupture the fibers, thus creating better entanglement of the fibers. The shaft, leaves, and stems of the raw fibers, mechanically ruptured by the hammermilling, have a greater surface area compared to non-hammermilled straw fibers.

The material/composition may include about 4 to 17, 5 to 15, or 6 to 14 wt. % of cellulose-containing material, component (B), based on the total weight of the composition/material. The weight percentage of component (B) may be about, at least about, or at most about 4, 5, 6, 7, 8, 9, 10, 11, 12, 13, 14, 15, 16, or 17 wt. %, based on the total weight of the composition.

The component (B), the cellulose-containing material, may include paper such as recycled paper or post-consumer paper waste such as copy paper, newspaper, newsprint, cardboard, molded fiber packaging such as egg cartons, paperboard and carton stock such as cereal boxes, packaging inserts, or their combination. The component (B) may be derived directly from cellulose-rich sources with minimal processing, often with mechanical, not chemical processing. The type of cellulose may include plant-derived, lignocellulosic cellulose. The cellulose may be processed by mechanical processing and retain lignin such as in newsprint. The cellulose may be a fibrous, high molecular weight cellulose with natural hemicellulose and residual lignin.

The component (B) may serve as a carrier for one or more components (C)-(I). The amount of components (A) and (B) together may be at least 85, 86, 87, 88, 89, 90, 91, 92, 93, 94, or 95 wt. %, based on the total weight of the composition.

The material/composition may include about 0.5 to 7, 2 to 6.4, or 4.5 to 6 wt. % of the natural binder or tackifier, component (C), based on the total weight of the composition/material. The weight percentage of component (C) may be about, at least about, or at most about 0.5, 06, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.7, 6.8, 6.9, or 7.0 wt. %, based on the total weight of the composition.

The component (C), a natural binder or tackifier, may include a naturally occurring gum such as guar gum, gum tragacanth, starch, psyllium, modified cellulose such as carboxyalkyl cellulose (carboxymethyl cellulose), hydroxyalkyl cellulose (hydroxypropyl methylcellulose), or their combination. The component (C) may be free of any synthetic, artificial or man-made binders.

The material/composition may include about 0.5 to 7, 2 to 6.4, or 4.5 to 6 wt. % of nutrients or fertilizer, component (D), based on the total weight of the composition/material. The weight percentage of component (D) may be about, at least about, or at most about 0.5, 06, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.7, 6.8, 6.9, or 7.0 wt. %, based on the total weight of the composition.

In at least one embodiment, the amount of the components (C) and (D) is substantially the same, meaning within about 1 wt. % of each other.

The component (D), nutrients or fertilizer, may include macronutrient, micronutrients, minerals, or their combination. For example, component (D) may include primary macronutrients N, P, K, Ca, Mg, and S; micronutrients B, Cl, Cu, Fe, Mn, Mo, Ni, Zn; carbon in the form of biochar, or their combination. Component (D) may be incorporated in a liquid form as an aqueous solution, solid form, or both. Component (D) may be incorporated as a slow-release or control release fertilizer (CRF), for example as a CRF with urea or NPK combination core and water-soluble polyolefin, polyurethane, or biodegradable coating.

A non-limiting example nutrient mixture may include urea, water insoluble nitrogen, and controlled release nitrogen from methylenediurea and dimethylenetriurea, together with a source of P, K, Ca, S, and Mg.

The material/composition may include about 0.4 to 2.4, 0.6 to 2.1, or 0.8 to 1.5 wt. % of aqueous solution of acids, component (E), based on the total weight of the composition/material. The weight percentage of component (E) may be about, at least about, or at most about 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, or 2.4 wt. %, based on the total weight of the composition.

The acids, component (E) may include a mixture of hydrochloric acid, phosphoric acid, oxalic acid, citric acid, or the like. In a non-limiting example, component (E) may include about 5-15, 8-12, or 9-11 wt. % of each hydrochloric acid and phosphoric acid and 1-5, 2-4, or 2.5-3.5 wt. % of each oxalic acid, citric acid, based on the total weight of component (E), the balance being water. The hydrochloric acid and phosphoric acid may be included in substantially the same amount, meaning within about 1 wt. % of each other. The oxalic and citric acid may be included in substantially the same amount, meaning within about 1 wt. % of each other. The acids may be an aqueous solution of acids. In a non-limiting example, the composition includes a mixture of hydrochloric acid and phosphoric acid.

The component (E) may be about 0.3 to 1.0, 0.4 to 0.8, or 0.5 to 0.60 wt. % of acids, based on the total weight of the composition/material. The weight percentage of component (E) may be about, at least about, or at most about 0.3, 0.32, 0.34, 0.36, 0.38, 0.40, 0.42, 0.44, 0.46, 0.48, 0.50, 0.52, 0.54, 0.56, 0.58, 0.60, 0.62, 0.64, 0.66, 0.68, 0.70, 0.72, 0.74, 0.76, 0.78, 0.80, 0.82, 0.84, 0.86, 0.88, 0.90, 0.92, 0.94, 0.96, 0.98, or 1.00 wt. %, based on the total weight of the composition.

The material/composition may include about 0.3 to 1.0, 0.4 to 0.8, or 0.5 to 0.60 wt. % of a crosslinker, component (F), based on the total weight of the composition/material. The weight percentage of component (F) may be about, at least about, or at most about 0.3, 0.32, 0.34, 0.36, 0.38, 0.40, 0.42, 0.44, 0.46, 0.48, 0.50, 0.52, 0.54, 0.56, 0.58, 0.60, 0.62, 0.64, 0.66, 0.68, 0.70, 0.72, 0.74, 0.76, 0.78, 0.80, 0.82, 0.84, 0.86, 0.88, 0.90, 0.92, 0.94, 0.96, 0.98, or 1.00 wt. %, based on the total weight of the composition.

The crosslinker, component (F), may include glyoxal, glycerin, or a combination thereof. Glyoxal is a dialdehyde with the chemical formula OCHCHO. Glycerin or glycerol is a simple triol compound with a chemical formula C₃H₈O₃.

The material/composition may include about 0.2 to 0.4, 0.22 to 0.35, or 0.23 to 0.29 wt. % of a surfactant, component (G), based on the total weight of the composition/material. The weight percentage of component (G) may be about, at least about, or at most about 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, or 0.40 wt. %, based on the total weight of the composition.

The surfactant, component (G) may include any compound that lowers the surface tension between components of the composition. Surfactants may be surface-active agents. The surfactants may be anionic, cationic, amphoteric, zwitterionic, non ionic, alkanolamides, the like, or their combination. The surfactants may be hydrophilic or hydrophobic. Non-limiting example surfactants include ethoxylates such as alcohol ethoxylates, fatty alcohol ethoxylates, octyl phenol ethoxylate, poloxamer, ammonium dodecyl sulfate or ammonium lauryl sulfate (ALS), sodium lauryl sulfoacetate (SLSA), decyl glucoside, sodium cocoyl isethionate, or their combination.

The surfactants may include soil penetrants or soil wetting agents. A soil penetrant is a material structured to improve soil quality by increasing its ability to absorb water and nutrients from the environment. A soil penetrant may lower surface tension between water and soil and allow soil to more easily absorb water and nutrients. A non-limiting example of soil penetrant may include polyhydroxy alkoxy alkylene oxides.

The material/composition may include about 0.2 to 0.4, 0.22 to 0.35, or 0.23 to 0.29 wt. % of biostimulants, component (H), based on the total weight of the composition/material. The weight percentage of component (H) may be about, at least about, or at most about 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, or 0.40 wt. %, based on the total weight of the composition.

Biostimulants, component (H), may include one or more substances or microorganisms which contribute to stimulate natural processes that improve plant characteristics such as tolerance to environmental stress such as pathogens, drought, salinity, extreme temperatures, efficiency of nutrient uptake by roots, and the like. Biostimulants may boost root growth during the first phenological stage of crops and may be beneficial to root development for plants in general. Biostimulants may include one or more types or classes of materials. For example, component (H) may include (a) inoculants, (b) biomass residue products, (c) extracts, (d) protein hydrolysates, (e) compost, (f) biopolymers, (g) biochar, or the like. Each individual class of biostimulants may be included in an amount of at least about 0.004, 0.008, or 0.01 wt. %, based on the total weight of the composition.

Inoculants are living microorganisms. Inoculants may include beneficial soil bacteria and/or fungi such as Baccilus pumilus, Trichoderma harzianum, Lactobaccilus, Rhizobia, Cyanobacteria, Mycorrhizae such as Endomycorrhizae such as Glomus intradices, Glomus aggregatum, Glomus mosseae, Ectomycorrhizae, or a combination thereof.

Biomass residue products may include humic substances such as humic acid, leonardite, fulvic substances such as fulvic acid, other colored recalcitrant organic compounds naturally formed during long-term decomposition and transformation of biomass residues, and combinations thereof.

Extracts may include extracts from plant parts such as leaf, root, or seed. The extracts may include seaweed extract, algal extract, herbal extract, or their combination.

Protein hydrolysates may include amino acids, bioactive peptides, or both. In a non-limiting example, the peptides may be isolated from soybean seeds or legume seeds.

Compost is a mixture of ingredients resulting from decomposition of plant and food waste, recycling organic materials, and manure. Compost may include plant nutrients, soil beneficial microorganisms such as bacteria, protozoa, nematodes, and fungi.

Biopolymers include natural polymers produced by living organisms, made up of repeating units covalently bonded together. Biopolymers may be derived from carbohydrates, proteins, fats. Biopolymers may include chitosan, a biopolymer derived from chitin.

Biochar is a carbonaceous material made by heating biomass in an oxygen-limited environment at high temperatures.

The material/composition may include about 0. to 5.0, 0.5 to 0.4, or 1 to 3 wt. % of additional components, component (I), based on the total weight of the composition/material. The weight percentage of component (I) may be about, at least about, or at most about 0, 0.1, 0.2, 0.22, 0.24, 0.26, 0.28, 0.30, 0.32, 0.34, 0.36, 0.38, 0.40, 0.42, 0.44, 0.46, 0.48, 0.50, 0.52, 0.54, 0.56, 0.58, 0.60, 0.62, 0.64, 0.66, 0.68, 0.70, 0.72, 0.74, 0.76, 0.78, 0.80, 0.82, 0.84, 0.86, 0.88, 0.90, 0.92, 0.94, 0.96, 0.98, 1.00, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, based on the total weight of the composition. The material/composition may be free of additional components, such that the wt. % of additional components may be 0.

The additional components may include one or more classes of materials such as clay. The inorganic mineral clay may include smectite clay(s) including the following minerals: montmorillonite, beidellite, nantronite, saponice, hectorite. The clay may be gray, red, or both. The clay may be calcined to form clay particles. The clay particles may be processed in the following manner for the purposes of the disclosed application. The clay may be calcined at a temperature of about 1000 to 1400, 1100 to 1350, or 1200 to 1300° F. or 537-760, 593-732, or 648-704° C. The clay may be subsequently sized or micronized, for example, by grinding. The clay may be provided in various sizes. Additional particles may include perlite, vermiculite, sand particles, zeolite, hydrated aluminosilicate minerals that contain alkali and alkaline-earth metals, or a combination thereof. The mineral particle(s) may be treated or untreated. The clay may be raw such as not processed by calcining. The composition may be free of ceramic particles or raw clay.

The additional components may include seeds. The seeds may include various species such as native species of grasses, herbs, and other plants.

In one or more embodiments, the composition includes components (A)-(I). In another non-limiting embodiment, the composition includes components (A), (B), (C), (E), and (F). In another non-limiting embodiment, the composition includes components (A)-(F).

In the first, second, or first and second state, the composition may have the following properties described below.

pH of the material may be about 5-7.5, 5.2-7, or 5.5-6.5. pH of the material may be about, at least about, or at most about 5, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, or 7.5.

Electrical conductivity (E/C) of the material may be less than 5, 4, 3, 2, 1, or 0.5 mmhos/cm. E/C of the material may be at most about 5, 4.9, 4.8, 47, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 1.9, 1.8, 1.7, 1.6, 1.5, 1.4, 1.3, 1.2, 1.1, 1.0, 0.9, 0.8, 0.7, 0.6, or 0.5.

Total porosity of the material may be about 75-95, 78-88, or 80-85%. The total porosity may be about, at least about, or at most about 75, 76, 77, 78, 79, 80, 81, 82, 83, 84, 85, 86, 87, 88, 89, 90, 91, 92, 93, 94, or 95%.

Container capacity of the material may be about 55-75, 58-70, or 60-65%. Container capacity of the material may be about, least about, or at most about 55, 56, 57, 58, 59, 60, 61, 62, 63, 64, 65, 66, 67, 68, 69, 70, 71, 72, 73, 74, or 75%.

Air space of the material may be about 10-30, 15-28, or 22-25%. Container capacity of the material may be about, least about, or at most about 10, 11, 12, 13, 14, 15, 16, 17, 18, 19, 20, 21, 22, 23, 24, 25, 26, 27, 28, 29, or 30%.

Container capacity, air space, and porosity were measured using JR Peters Laboratory Allentown, PA, USA, using “Procedures for Determining Physical Properties of Horticultural Substrates Using the NCSU Porometer by Horticultural Substrates Laboratory,” Department of Horticultural Science, North Carolina State University in Raleigh, North Carolina, which is incorporated in its entirety by reference herein.

A process for producing the pelletized material is disclosed herein. The process may include hammermilling one or more of the individual components. The components may be hammermilled separately or together. An alternative to hammermilling may be grinding in a tub grinder. The hammermilling or grinding may be conducted once or more times, for example twice.

In a non-limiting example, component (B) may be loaded with components (C)-(I). Subsequently, components (A) and (B) may be loaded onto conveyor belts and processed through a hammermill. The components (A) and (B) may be mixed prior to entering a hammermill.

Subsequently, the hammermilled or ground materials may be screened, mixed together, mixed with additional materials, or a combination thereof.

Subsequently, the material may be pelletized in a pellet mill. The pellets may be formed under heat, pressure, or both in a dye by extrusion.

The pellets may be cooled and/or dried before storage. The storing of the pellets may be in a container such as a bag, tub. The container may be enclosable, resealable, or both. The bag may include a natural or synthetic material, which may be waterproof to protect the pellets from swelling and rupturing prematurely.

A method of using the pelletized material is disclosed herein. The method may include applying the disclosed pelletized material in its first state at an application density disclosed herein. The method may include spreading the pelletized material by a spreader, helicopter, by hand, or a combination thereof. The method may include dry hydroseeding of the pellets under pressure. The method may include dry application with no addition of water. The method may include application of moisture on the area including the pellets to initiate transition of the pellets from the first state to the second state.

Once applied in the first state, the pellets remain in their location of application, not being picked up by wind and not rolling downhill due to gravity. The pellets may be thus applied in areas with natural low humidity such that the pellets remain in the area until humidity increases. When ambient or induced moisture reaches a threshold amount, and the moisture content of the pellets increases above about 15%, based on the weight of the pellet, the pellets transition from the first state to the second state due to swelling of the pelletized components and subsequent rupture.

Once ruptured, the pelletized material changes from an elongated cylinder with smooth surface (first state) into a fibrous material having frayed, rough, or fluffy texture (second state). In the second state, the material may be tacky to touch, further increasing its ability to remain at the application site. Unlike some of the state-of-the-art mulches, the rate of rupture for the herein-disclosed material is at least about 95, 96, 97, 98, 99, or about 100%, based on a total amount of applied pellets.

### EXPERIMENTAL SECTION

### Examples 1-3

A trial was prepared using Examples 1, 2, and 3, which were prepared from components shown in Table 2. Examples 1, 2, 3, had the same composition.

TABLE 2
Composition of Examples 1, 2, and 3

| Component | Quantity [wt. %] |
|---|---|
| Straw | 87.1 |
| Tackifier | 5.1 |
| Nutrients | 5.5 |
| Aqueous solution of acids | 0.8 |
| Crosslinker | 0.5 |
| Surfactant | 0.3 |
| Biostimulants | 0.2 |
| Mineral clay | 0.5 |

The composition of Examples 1, 2, 3, was prepared as described above.

Examples 1, 2, 3 and were applied on three trays filled with coal mine spoils as a substrate, which is shown in FIG. 3 in detail. All 3 trays had the same density of seeds distributed throughout the surface of the coal mine spoils. Example 1 had the same application density as Example 3 at 86.77 g. This density was higher than application density of Example 2 at 57.85 g. Examples 1 and 2 had the same coarseness of the coal mine spoils (soil sieve: ¼″ screen) while Example 3 was applied onto a substrate with greater coarseness.

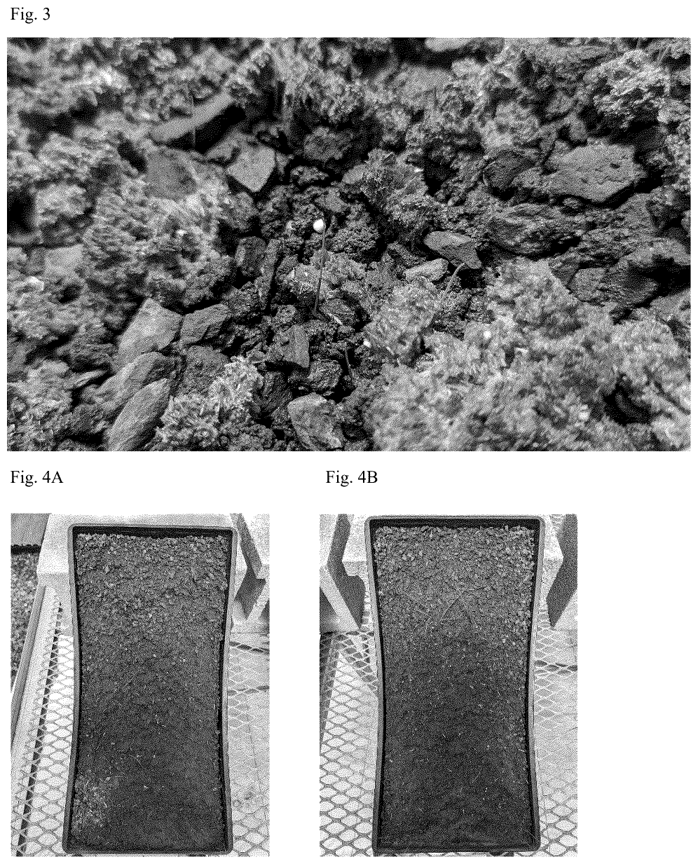

Two controls, Comparative Examples A and B, were installed and trialed under the same conditions (same watering regime, temperature, access to light, no additional fertilizer application). The Comparative Examples A and B had the same coal mine spoils substrate as Examples 1 and 3 (soil sieve: ¼″ screen) with no mulch and no fertilizer applied; Comparative Example B had no mulch, but included fertilizer in the same amount as Examples 1, 2, and 3. Comparative Example A is shown in FIG. 4A and Comparative Example B is shown in FIG. 4B at the start of the trial.

Moisture was applied onto Examples 1, 2, 3, and Comparative Examples A and B. As a result of the moisture application, the pellets of Examples 1, 2, and 3 swelled and ruptured. The trays with Examples 1, 2, and 3 after swelling are shown in FIG. 3. Example 1 is on the left, Example 2 in the middle, and Example 3 on the right. The trays with Examples 1, 2, 3, and Comparative Examples A and B were installed at an angle of 26.6° to simulate conditions of a natural slope.

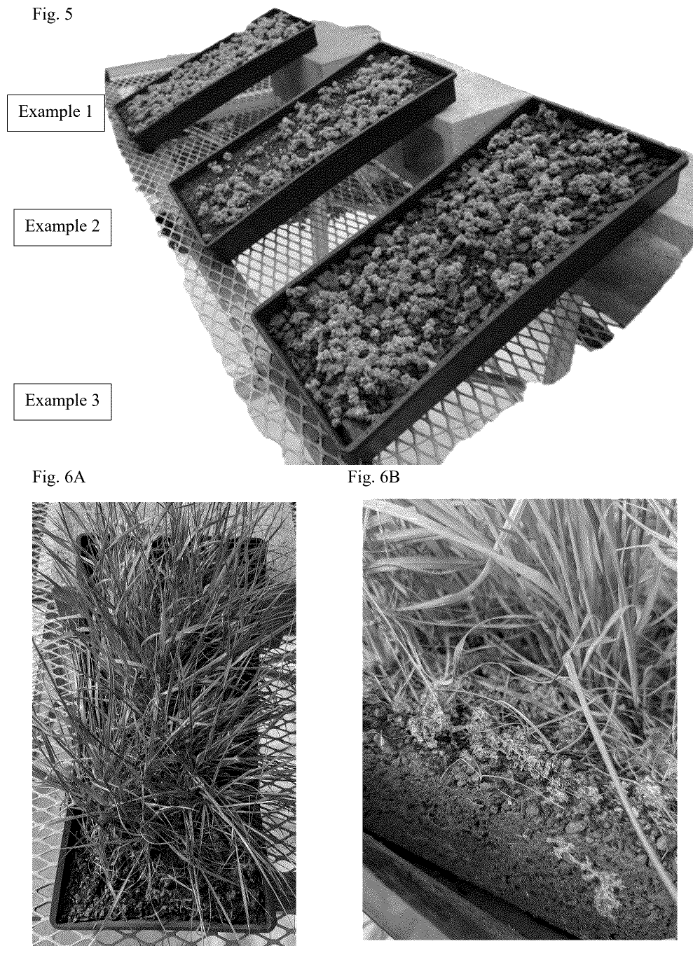

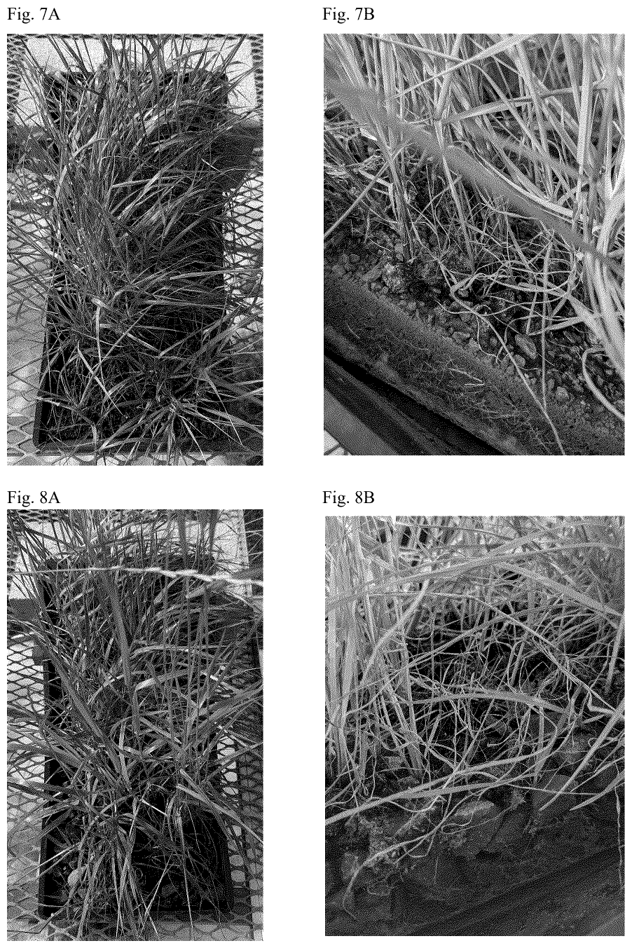

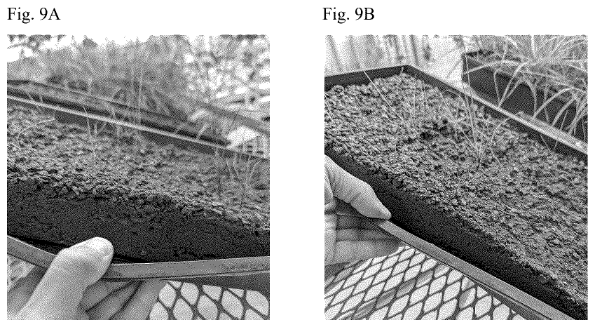

A 9-week trial demonstrated good performance of Examples 1, 2, and 3. FIGS. 6A and 6B show Example 1, FIGS. 7A and 7B show Example 2, and FIGS. 8A and 8B show Example 3 after nine weeks of the trial. FIGS. 9A and 9B show Comparative Examples A and B, respectively, after nine weeks of the trial.

Additionally, data regarding shoot tissue dry weight, height of the shoots, and visible species count was assessed for Examples 1, 2, 3, and Comparative Examples A and B. The results are shown in Table 3.

TABLE 3
Results of a 9-week trial for Examples 1,
2, 3, and Comparative Examples A and B

| | Mulch | | Shoot tissue | Visible | |
|---|---|---|---|---|---|
| Example | Rate | | dry weight | species count | Height |
| No. | [g] | Fertilizer | [g] | [#] | [cm] |
| 1 | 86.775 | Yes | 31.51 | 3 | 70 |
| 2 | 57.85 | Yes | 32.90 | 3 | 75 |
| 3 | 86.755 | Yes | 27.78 | 3 | 68 |
| A | 0 | No | 0.20 | 2 | 10 |
| B | 0 | No | 0.81 | 2 | 22 |

As can be observed from the data of Table 3 and the photographs of FIGS. 6A-9B, the control trays were scarcely vegetated. In sharp contrast, the trays featuring the herein-disclosed composition provided thick vegetation with good high of plants and had increased biodiversity in comparison to the controls.

### Examples 4-7

TABLE 3
Composition of Examples 4-7

Quantity [wt. %]
Example No.

| Component | 4 | 5 | 6 | 7 |
|---|---|---|---|---|
| Straw | 84 | 87 | 89.7 | 90 |
| Cellulose-containing | 7.5 | 4.5 | 5.2 | 5 |
| material (newsprint) | | | | |
| Tackifier | 4.7 | 6.9 | 3.5 | 1.5 |
| Nutrients | 2.6 | 0.4 | 0.5 | 2.4 |
| Acids | 0.3 | 0.3 | 0.3 | 0.3 |
| Crosslinker | 0.2 | 0.2 | 0.3 | 0.3 |
| Surfactant | 0.3 | 0.2 | 0.2 | 0.2 |
| Biostimulants - | 0.2 | 0.4 | 0.3 | 0.2 |
| inoculants | | | | |
| Mineral clay | 0.2 | 0.1 | 0 | 0.1 |

The compositions of Examples 4-7 were prepared as described above and provided satisfactory results in their second state after application.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A mulch and soil amendment comprising:
a plurality of pellets, each having
a first state of being an extruded compact elongated body having a smooth surface, and
a second state of being a non-compact material having a rough surface, each pellet, of the mulch and soil amendment, having a composition comprising:
straw;
cellulose material;
tackifier;
crosslinker; and
aqueous solution of acids.

2. The mulch and soil amendment of claim 1, wherein the straw includes alfalfa.

3. The mulch and soil amendment of claim 1, wherein the composition includes about 80 to 95 wt. % straw, based on a total weight of the composition.

4. The mulch and soil amendment of claim 1, wherein the composition further includes a fertilizer and the amount of the tackifier and the fertilizer is within 1 wt. % of each other, based on the total weight of the composition.

5. The mulch and soil amendment of claim 1, wherein the aqueous solution of acids includes a mixture of hydrochloric acid and phosphoric acid.

6. The mulch and soil amendment of claim 1, wherein the composition further includes inoculants of Mycorrhizae.

7. The mulch and soil amendment of claim 1, wherein the crosslinker includes glyoxal.

8. A pelletized material comprising:
a plurality of pelletized extruded and compact bodies, each one of the bodies having a compressed mass of a mulch and soil amendment composition, each one of the bodies having a moisture content of at most about 15 wt. %, based on the total weight of a body, in its inactive first state,
at least about 10 wt. % of the pelletized extruded and compact bodies being angular with non-rounded geometry, based on the total weight of the pelletized material.

9. The pelletized material of claim 8, wherein the plurality of pelletized extruded and compact bodies has a second active state of being expanded at a moisture content greater than about 15 wt. %, based on the total weight of the pelletized material.

10. The pelletized material of claim 8, wherein the angular bodies are irregularly shaped.

11. The pelletized material of claim 8, wherein some of the plurality of pelletized extruded and compact bodies vary in length relative to one another.

12. The pelletized material of claim 8, wherein the mulch and soil amendment composition includes straw, cellulose material, tackifier, crosslinker, and aqueous solution of acids.

13. The pelletized material of claim 12, wherein the cellulose material includes paper.

14. The pelletized material of claim 12, wherein the composition further includes one or more of fertilizer(s), surfactant(s), and biostimulant(s).

15. A pelletized material comprising:
a plurality of pellets, each pellet having, in a first state, a moisture content of at most about 15 wt. %, based on a total weight of the pellet, and maintaining a compressed geometry; and
upon exposure to moisture, a second state, in which the pellet swells such that at least one dimension of the pellet increases relative to the first state, the pellet in the second state being configured to rupture and disintegrate into a plurality of portions smaller than the compressed geometry of the first state,
the pelletized material being a straw-based mulch and a soil amendment composition.

16. The pelletized material of claim 15, wherein the straw-based mulch and a soil amendment composition includes:
straw;
cellulose material;
tackifier;
crosslinker; and
aqueous solution of acids.

17. The pelletized material of claim 15, wherein the plurality of pellets includes at least a portion of the pellets having angular, non-round pellets.

18. The pelletized material of claim 16, wherein the aqueous solution of acids includes a mixture of hydrochloric acid and phosphoric acid.

19. The pelletized material of claim 16, wherein the straw and cellulose material form at least 85 wt. % of the composition, based on the total weight of the composition.

20. The pelletized material of claim 16, wherein the composition further includes one or more of fertilizer(s), surfactant(s), and biostimulant(s).
